(19) United States
(12) Patent Application Publication
(10) Pub. No.: US 2024/0348679 A1
(43) Pub. Date: Oct. 17, 2024

(54) SYSTEMS AND METHODS FOR SECURE FILE DISTRIBUTION

(71) Applicant: OpenMedia Technologies, Littleton, CO (US)

(72) Inventors: Duke Duong, Irvine, CA (US); John Patti, Gravette, AR (US)

(21) Appl. No.: 18/630,803

(22) Filed: Apr. 9, 2024

Related U.S. Application Data
(60) Provisional application No. 63/458,382, filed on Apr. 10, 2023.

(51) Int. Cl. H04L 67/06; G06F 21/56

(52) U.S. Cl. CPC H04L 67/06; G06F 21/565

(57) ABSTRACT

A system for secure file transfers between an on-site device and one or more remote storage devices, whereby the on-site computing device includes one or more file input interfaces that receive data files. The computing device validates the data files and transmits them to the remote storage devices. The on-site computing device does not have a way for on-site personnel to interact with the device, other than in some embodiments inserting a memory card for file transfers.

This application claims priority to U.S. provisional application 63/458,382, filed Apr. 10, 2023. U.S. provisional application 63/458,382 and all other extrinsic references contained herein are incorporated by reference in their entirety.

### FIELD OF THE INVENTION

The field of the invention is secure file transfer technologies.

### BACKGROUND

The background description includes information that may be useful in understanding the present invention. It is not an admission that any of the information provided herein is prior art or relevant to the presently claimed invention, or that any publication specifically or implicitly referenced is prior art.

A challenge associated with shooting digital video in studio or on location is that once the footages are captures, it is a manual process to get them digitized for use. This encompasses, Film, Television and VFX production. Camera footage is captured on SSD cards that must be manually uploaded using a card reader to the desired storage location (locally then remote), one SSD card at a time. To get the SSD cards to this upload location it is a manual process either “sneaker net” (i.e., a person literally taking the card with them from the location to the storage location), mail service, or other pay delivery methods.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for a improved way to securely and quickly transfer onsite video and audio data to a remote storage location.

### SUMMARY OF THE INVENTION

The inventive subject matter provides apparatus, systems and methods in which a computing device includes a file input interface and a processor that executes stored instructions to receive one or more data files via the file input interface, validate the files and automatically route one or more of the data files to a remote server. In preferred embodiments, the computing device includes no user input/output interfaces such that a user on-site cannot manipulate the device. In these embodiments, this can mean that the computing device can only receive updated instructions and other instructions from a remote computing device—it cannot receive user input on-site.

In embodiments of the inventive subject matter, the data files can be raw data files.

In embodiments of the inventive subject matter, the file input interface can be a card reader configured to receive a memory card, which carries the data files. The data files can one or more of an audio or a video data file that is generated by a camera.

In embodiments of the inventive subject matter, the file input interface can be a wireless interface whereby a camera or other source of data can connect to the computing device and provide the data files wirelessly.

In embodiments of the inventive subject matter, the computing device includes a plurality of file input interfaces capable of receiving a plurality of data files. In these embodiments, the processor of the computing device is programmed to receive, via the plurality of file input interfaces, the plurality of data files and then process the received plurality of data files according to a check-in logic and check-out logic, and automatically route the plurality of data files to one or more remote servers according to the check-out logic.

The check-in logic and/or the check-out logic can be processed based on the number of cameras making up the plurality of cameras, camera types, designated priority of cameras, or other factors.

The computing device validating the data files can include verifying the integrity of one or more of the data files.

Various objects, features, aspects and advantages of the inventive subject matter will become more apparent from the following detailed description of preferred embodiments, along with the accompanying drawing figures in which like numerals represent like components.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWING

FIG. 1 is a diagrammatic overview of an example system according to embodiments of the inventive subject matter.

FIG. 2 is a diagrammatic overview of a computing device used in a system according to embodiments of the inventive subject matter.

FIG. 3 provides an illustrative flowchart of the processes of embodiments of the inventive subject matter.

FIG. 4 shows a diagrammatic overview of the machine learning components of computing device, according to embodiments of the inventive subject matter.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

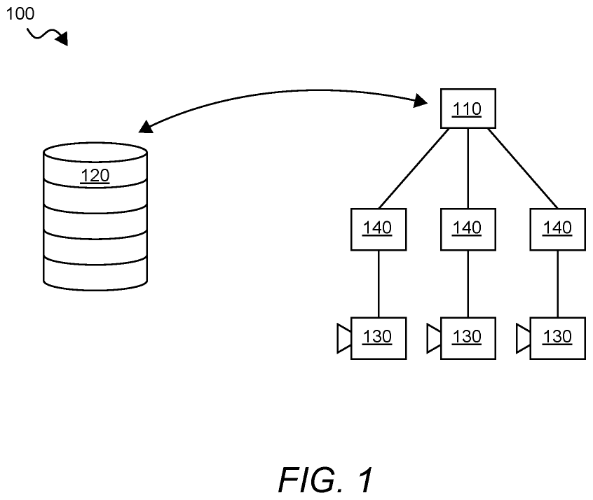

FIG. 1 shows a diagrammatic overview of a system 100, according to embodiments of the inventive subject matter.

Computing device 110 is a computing device that is deployed locally to data sources 130. In the examples discussed herein, the data sources 130 are cameras that capture digital image data (stills and/or video) and/or audio data. Spatially, “locally” is considered to refer to a distance of less than a mile geographically. Thus, “locally” can be considered to be within a same building, within a same location (e.g., lot, filming location, city block, etc.). In embodiments, “locally” can be a smaller distance—e.g., within 50 yards. For data communications purposes, locally can be considered to be part of a same local-area network (“LAN”) or within short-range wireless communications (e.g., Bluetooth, NFC, 5G, etc.). The cameras 130 include an interface to receive a memory card 140, in which it can store image and/or sound data.

In embodiments of the inventive subject matter, the cameras 130 are cinema-quality cameras that capture digital imagery (e.g., one or more of video data and still image data). The quality of the images captured result in large file sizes. For example, some types of cameras 130 can capture digital image at HD (4K-8K resolution) which result in large data files for memory cards that are currently typically 2-4 TB in size.

The data sources 130 can also include sources of audio data. This can be the cameras themselves, or separate audio sensors (e.g., microphones) that captures sound in the environment and can export it in the form of sound data files.

In embodiments such as the ones discussed herein, data files from the cameras 130 can be transferred to the computing device 110 via memory cards 140. Memory cards 140 are considered to be solid state drive (“SSD”) cards, however other types of memory cards 140 can be used. In embodiments, the memory cards 140 can be local external hard drives that can be connected to cameras 130 to store captured image data files and then be connected to the computing device 110 to transfer the data files to the device 110.

In some embodiments of the inventive subject matter where cameras 130 are sufficiently portable, the memory cards 140 can instead be a cable link from the camera 130 directly to the computing device 110 via a wired data exchange interface.

In other embodiments of the inventive subject matter, the data files can be transferred from the cameras 130 to the computing device 110 via short-range wireless (e.g., Bluetooth, NFC, local WiFi, 5G, etc.) or via local wired data connections.

As will be discussed in further detail below, the computing device 110 securely transmits the data files to a remote storage computing device 120. The remote storage computing device 120 can be one or more server(s) belonging to or operated by a production studio or other organization that has an interest in the content being created.

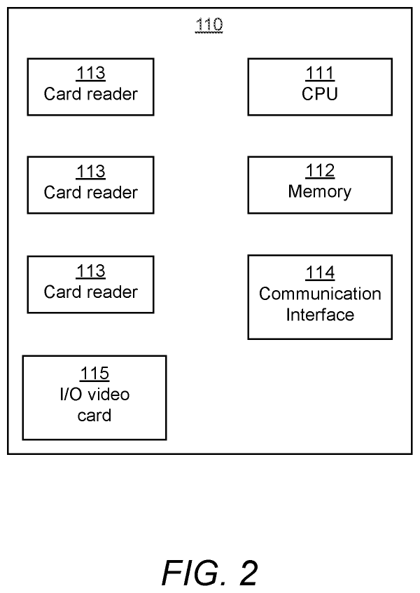

FIG. 2 shows a diagrammatic overview of the computing device 110.

As seen in FIG. 2, computing device 110 includes one or more processors 111, one or more storage media 112 (e.g., hard drives, solid state drives, etc.), one or more file input interfaces 113 and one or more communication interfaces 114.

In embodiments of the inventive subject matter such as the embodiments shown herein, the file input interfaces 113 can be card readers that are configured to receive and read data from the memory cards 130.

In embodiments of the inventive subject matter, the computing device 110 can include a video capture card 115 in addition to the card reader(s) 113. The video capture card 115 can allow for the capture of video directly from a camera or other video source, allowing for live feeds as well as other additional options.

The communication interfaces 114 allow for the exchange of data with remote and/or local devices. The communication interfaces 114 can include wired or wireless (e.g., WiFi) data exchange interfaces that allow for the sending of data over the internet. The communication interface can also include additional communication modalities (e.g., cellular) for the exchange of data.

In preferred embodiments of the inventive subject matter, the computing device 110 does not have any input/output interfaces that can be used by on-site personnel to interact with the computing device 110. The only thing that on-site personnel can do with the device is plug it in/unplug it and insert memory cards into and remove memory cards 140 from memory card readers 113. Software updates, instructions regarding the transfer of files (their priority, their destination(s), etc., troubleshooting, etc., are all performed from a remote computing device that can communicate with the computing device 110 via the communication interface(s) 114. Thus, to the extent that the computing device 110 may have a screen to present data (such as progress data), a speaker to emit audio cues, and/or lights that indicate processes are working, finished, etc., all of these are “read only” in that a user local to the computing device 110 cannot add anything.

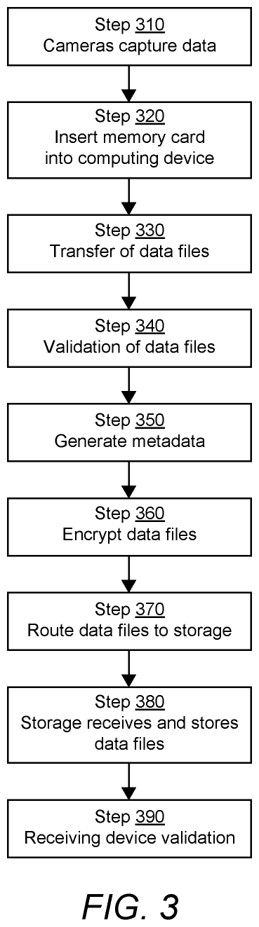

FIG. 3 provides an illustrative flowchart of the processes of embodiments of the inventive subject matter.

At step 310, one or more of the cameras 130 captures image data (and optionally, sound data) at the location and stores the captured data as one or more data files in one or more memory card(s) 140.

At step 320, when the filming has concluded or when the memory card(s) 140 is/are full, a user removes them from the camera 130 and inserts them into memory card reader(s) 114.

As a part of step 320, the computing device 110 can apply machine learning to determine the most efficient path for the data upload from the computing device 110 to the storage device(s) 120.

To do so, the machine learning component of computing device 110 first analyzes the available connection speed of the various available transmission methods (e.g., cellular, ethernet, fiber, etc.) and then determines the most efficient path for the transfer based on a typical or anticipated file size and calculates the overall upload/latency by consuming BGP for connected terrestrial/cellular networks. This is discussed in additional detail below.

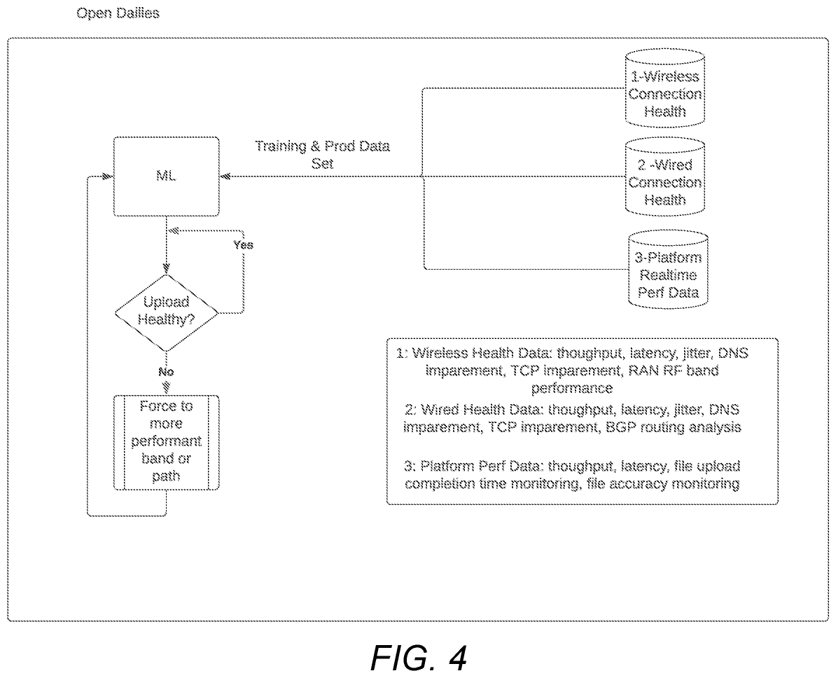

At system setup and during the life of the computing device 110, the machine learning component is trained such that it is constantly adapting and learning to better carry out its processes. The training data can be simulation data or historical live data regarding wireless connection health, wired connection health and platform real-time performance data. Actual data gathered while the computing device 110 performs its functions can also be used as training data for the machine learning component. FIG. 4 shows a diagrammatic overview of the machine learning components 410 of computing device 110.

At step 330, the computing device 110 detects that memory cards 140 have been inserted into readers 114 and begins the check-in process of steps 330-350 by initiating the transferring the data files to its local memory 112 for all subsequent processing. Once the data transfers are complete, the computing device 110 can delete the copy of the data from the memory cards 140 so that they are ready for further use.

At step 340, the computing device 110 validates the received data byte for byte. The validation process is a quality control (“QC”) process whereby the computing device validates the integrity of the received video data to ensure there are no issues or problems with the data. This can include check-sum calculations on files in the memory cards 140 as well as the received files stored by the computing device 110 in the local memory 112, reviewing the data for playback-ability and to check for defects in the data that could affect the quality of the playback, as well as validating aspects of the files such as file formats, video/audio presence and discontinuity validation, audio/video essence validation based on user defined QC parameters.

At step 350, the computing device 110 generates metadata for the data files and tags the data file(s) with the appropriate metadata. The metadata can include time/date information, production-specific information (e.g., scene, etc.), technical information, location information, etc. In embodiments of the inventive subject matter, the computing device 110 does not delete the data from the memory cards 140 until after the data files have been validated and the metadata generated and added to the data files.

If the validation process of step 340 fails, the computing device 110 can start the process by once again copying the data files from the memory card 140 and executing the above steps over again. The computing device 110 can be programmed to attempt this a pre-determined number of time (for example, 3 times) before it sends an error message to the controlling entity that can access the computing device 110 remotely.

Optionally, the computing device 110 can encrypt the data files at step 360.

In embodiments of the inventive subject matter, the computing device can instantiate machine learning on the validation processes discussed herein.

At step 370, the computing device 110 routes the data files to one or more of the storage devices 120 according to a check-out logic. The storage device(s) 120 can be physically located anywhere in the world.

The check-out logic includes a bit-by-bit validation and integrity check of the files as they are being transferred. In other words, the computing device 110 validates and performs integrity checks on the outgoing files so that it can ensure that at the transmission stage the files are not corrupted or otherwise changed in an undesirable manner.

The transmission of the data files between the computing device 110 to the storage device(s) 120 can be over a direct line internet service offered by service providers that provides fast, secure data transfer for a particular client.

It should be noted that the processes executed by the machine learning component of computing device 110 discussed with regard to step 320 can be ongoing throughout the processes discussed herein. Thus, the machine learning component can recalculate the most efficient path based on the actual file sizes after the memory cards 140 have been introduced and the actual file sizes determined. Likewise, the machine learning component can continually determine the most efficient path before and even during the file transfers such that the computing device 110 can adapt to changing network conditions to ensure a complete, accurate, and rapid transfer of the files.

The following are additional details regarding the operation of the machine learning component 410 of FIG. 4. As seen in FIG. 4, the computing device 110 (and thus, the machine learning component 410) can obtain one or more of wireless connection health data 401, wired connection health data 402, and real-time platform performance data 403.

The wireless connection health data 401 can include data such as throughput data, latency data, jitter data, DNS impairment data, TCP impairment data, RAN RF band performance data, etc.

The wired connection health data 401 can include data such as throughput data, latency data, jitter data, DNS impairment data, TCP impairment data, BGP routing analysis data, etc.

The real-time platform performance data 403 can include throughput data, latency data, file upload completion time monitoring data (e.g., data reflecting how long a file upload took to complete), and file accuracy monitoring data (e.g., how accurately a given file was transferred, without losses).

The machine learning component 410 then uses the data received to continually determine if the files sent to the storage device(s) 120 have been properly received (i.e., whether the uploads can be considered “healthy”). In embodiments, this occurs by receiving a confirmation message from the storage device(s) 120.

If so, the computing device 110 continues sending files using the same network paths and conditions as the prior files.

If the machine learning component 410 determines that any of the files were not a “healthy upload”, the machine learning component 410 continues the transfer of additional files by selecting a new path.

Then machine learning component 410 then continues to receive feedback from the storage device 120 regarding the success/failure of receiving subsequent healthy file uploads and repeats the process.

As noted above, one or more of wireless connection health data 401, wired connection health data 402 and real-time platform performance data 403 can be used to train the machine learning component 410.

At step 380, the remote storage devices 120 receive and store the data files. The organization or parties operating the remote storage device 120 can then access the data files and decrypt them for us.

At step 390, the remote storage devices 120 perform their own validation processes of the received data files. The validation process can be one that mirrors the validation performed by computing device at step 340, and can further include validating the metadata that was created and attached at step 350.

Benefits of the systems and methods of the inventive subject matter include decreased transfer time and increased security. Using “sneaker net” or mail delivery methods can take minutes, hours or days. Using these methods requires a trust that the SSD cards containing valuable content are secure and will not be tampered with. In the systems and methods of the inventive subject matter, the process is fast-a 2 TB SSD upload can currently take approximately 8 minutes. Once the files are uploaded, the transfer protocol used herein is fully encrypted. Thus, the systems and methods of the inventive subject matter can save 8 to 12 man hours a day.

Additional benefits for the systems and methods of the inventive subject matter include an ability for studio executives or other authority figures to provide feedback based on the received image files in minutes. This can allow for reshoots on the same day while the film crew is still on location, before the locations have been taken down or otherwise altered, and to take advantage of a relatively similar sun position for consistency in shots. They can also identify whether there are any technical problems with the cameras based on the quality of the received data files that might not be evident on-site, providing feedback before additional takes are potentially ruined that day.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for the management and transfer of sensitive data files, comprising a computing device that comprises:
a processor;
a file input interface;
a non-transitory computer readable medium storing instructions that, when executed by the processor, causes the processor to:
receive, via the file input interface, at least one data file;
validate the at least one data file; and
automatically route the at least one data file to a remote server;
wherein the computing device has no user input/output interfaces.

2. The system of claim 1, wherein the at least one data file comprises at least one raw data files.

3. The system of claim 1, wherein the file input interface comprises a card reader configured to receive a memory card.

4. The system of claim 1, wherein the file input interface comprises a wireless interface.

5. The system of claim 1, wherein the at least data file comprises at least one of an audio data file and a video data file generated by a camera.

6. The system of claim 5, further comprising a plurality of cameras that generate a plurality of data files, the system further comprising a plurality of file input interfaces and instructions that cause the processor to:
receive, via the plurality of file input interfaces, the plurality of data files;
process the plurality of data files according to a check-in logic and check-out logic; and
automatically route the plurality of data files to the at least one remote server based on the check-out logic.

7. The system of claim 6, wherein the check-in logic and check-out are processed based on the number of cameras within the plurality of cameras.

8. The system of claim 1, wherein validating the at least one data file comprises verifying the integrity of the at least one data file.

9. The system of claim 1, wherein the computing device is programmed to receive updated instructions only from at least one remote computing device.
